(19) United States
(12) Patent Application Publication
(10) Pub. No.: US 2014/0225292 A1
(43) Pub. Date: Aug. 14, 2014

(54) MOLD MONITORING FOR UNAUTHORIZED USE

(71) Applicant: Glenn Starkey, Wauconda, IL (US)

(72) Inventor: Glenn Starkey, Wauconda, IL (US)

(21) Appl. No.: 14/252,413

(22) Filed: Apr. 14, 2014

Related U.S. Application Data
(63) Continuation-in-part of application No. 13/115,197, filed on May 25, 2011.
Application No. 13/115,197 is a continuation-in-part of application No. 12/818,684, filed on Jun. 18, 2010.
Application No. 12/818,684 is a continuation-in-part of application No. 13/648,931, filed on Oct. 10, 2012.
(60) Provisional application No. 61/268,957, filed on Jun. 18, 2009.
(60) Provisional application No. 61/545,394, filed on Oct. 10, 2011.

(51) Int. Cl. B29C 45/76

(52) U.S. Cl. CPC B29C 45/76; B29C 2945/76254; B29C 2945/76993; B29C 2945/76173
USPC 264/40.1

(57) ABSTRACT

A monitor for a reciprocating tool reporting the removal of the monitor from the tool, for determination of a reason for removal, such as routine maintenance cleaning, unauthorized use of the mold to produce parts, and the like. The reason for removal can be reported to any party, including but not limited to an owner of the mold, an OEM manufacturer, a moldmaker and/or a molder.

### CROSS REFERENCE TO RELATED APPLICATIONS

This application claims priority to each and every one of the following applications and is a continuation-in-part of U.S. patent application Ser. No. 13/115,197, filed on 25 May 2011, which is a continuation-in-part of U.S. patent application Ser. No. 12/818,684, filed on 18 Jun. 2010, which claims the benefit of U.S. Provisional Patent Application Ser. No. 61/268,957, filed on 18 Jun. 2009, and is a continuation-in-part of U.S. patent application Ser. No. 13/648,931, filed on 10 Oct. 2012, which claims the benefit of U.S. Provisional Patent Application Ser. No. 61/545,394, filed on 10 Oct. 2011.

### CROSS REFERENCE TO AND INCORPORATION BY REFERENCE OF RELATED APPLICATIONS

The entire teachings of each and every one of U.S. patent application Ser. No. 13/115,197, which was filed on 25 May 2011, of U.S. patent application Ser. No. 12/818,684, which was filed on 18 Jun. 2010, of U.S. Provisional Patent Application No. 61/268,957, which was filed on 18 Jun. 2009, of U.S. patent application Ser. No. 13/648,931, which was filed on 10 Oct. 2012, and of U.S. Provisional Patent Application No. 61/545,394, which was filed on 10 Oct. 2011, are incorporated into this Specification by reference.

### BACKGROUND OF THE INVENTION

1. Field of the Invention

The present invention relates to a mold monitoring system.

2. Discussion of Related Art

Injection molds were in the past permitted to run in the press for very long part runs; and the mold was seldom removed from the press for storage. In these past systems, the molds were continuously associated with the press so that cycle counters on the press itself could be relied upon to provide the number of cycles of the mold and this was used to provide information relative to preventative maintenance, such as cleaning of the mold or lubricating critical surfaces.

Contemporary manufacturers utilize “just-in-time” practices wherein the purchaser does not maintain an inventory of large quantities of plastic parts, but manufactures the parts in smaller batches to be delivered on an “as-needed” basis. Such just-in-time practices may require molds to be swapped in and out of the press to produce different parts on an as-needed basis. As a result, press cycle counters which count the number of cycles of the press, can no longer be relied upon for maintenance schedules because a series of different molds is used in the press for relatively short periods of time.

Currently, records may be kept as to when and how long a particular mold has been run using mechanical counters that are affixed to the respective molds. Such mechanical counters include the COUNTERVIEW cycle counter manufactured by Progressive Components International Corporation of Wauconda, Ill. Starkey, U.S. Pat. No. 5,571,539 is incorporated herein by reference and teaches one such mechanical counter. Such mechanical counters reveal a running tally of the number of cycles that a particular mold has run but little else about the manufacturing process.

Mechanical counters such as the COUNTERVIEW cycle counter may positively monitor mold activity and validate process monitoring data. In addition, a serial number may be physically affixed to a surface of the COUNTERVIEW cycle counter for association between the cycle counter and the particular mold. As a result of the association between the cycle counter and the mold, a manufacturer may then monitor mold data and thereby improve mold maintenance.

Such mechanical counters may be susceptible to physical tampering and also may result in inaccurate record keeping because of the reliance on human operators to verify and transcribe mold cycle counts and/or serial numbers. Improper or infrequent record keeping associated with a particular mold may have negative effects on the maintenance of the mold and/or maintaining a desired inventory of resulting parts. Obviously, without the proper maintenance of an injection mold, damage may occur and down time may also be the result. Likewise, failure to maintain a desired inventory of parts may have serious consequences on resulting production.

Some molders have been known to make or mold unauthorized or additional parts, for example, without the knowledge and/or authorization of the owner of the mold. Often times, the unauthorized use of the mold is difficult for the owner to detect because many conventional counters can easily be removed, the unauthorized parts molded, and then the counter replaced, so that the counter starts counting again but with a false reading, quite often a lower reading.

Thus, there remains a need for an improved cycle counter and manufacturing monitor and an improved method for tracking and/or reporting manufacturing parameters and practices, particularly where unauthorized removal of the cycle counter can be detected locally and/or remotely.

### SUMMARY OF THE INVENTION

In accordance with the present invention, an injection plastic mold or similar actuating manufacturing tool is provided with a monitor, which is actuated with each opening and closing cycle of the mold to maintain a count of the operating cycles performed, as well as additional information about the mold and its operation. The monitor is preferably relatively inexpensive and unobtrusive and capable of withstanding severe environments including extreme temperatures and shock that may be encountered in a molding operation. This information is maintained or associated with the monitor in the mold, whether the mold is on the press or a storage rack, and may be retrieved remotely or directly from the monitor. In addition, the information generated by the monitor may be allocated among the OEM manufacturer, the moldmaker and the molder as desired by the owner of the tool and several reporting options are available for this purpose.

In some embodiments of this invention, the monitor can be used to identify and/or track time periods and/or other conditions that the monitor, particularly the cycle counting or other production counting aspect of the monitor, has been removed from normal molding operations, for example, to identify unauthorized moldings of the corresponding parts produced by the molds. The owner and/or any other interested authorized party can access reports detailing each unauthorized use, which can be accessed locally and/or remotely.

In some embodiments of this invention, the monitor can be used to sense and analyze maintenance histories of the mold or tool and any associated component or element. The monitor can be programmed to provide an alert to the user of an upcoming due date for one or more preventive maintenance activities. In some embodiments of this invention, the monitor can display locally a visual alert and/or sound an audible alert, and/or in other embodiments of this invention, the monitor can send out or emit a signal or signals to communicate remotely information about preventive maintenance schedules and/or requirements.

Other features and advantages of the invention will be apparent from the following detailed description taken in conjunction with the following figures, wherein like reference numerals represent like features.

### BRIEF DESCRIPTION OF THE DRAWINGS

FIG. 1 shows a monitor according to a preferred embodiment of this invention;

FIG. 2 shows a monitor placed within a mold according to one preferred embodiment of this invention;

FIG. 3 shows various information sets as shown on a display of the monitor according to one preferred embodiment of this invention;

FIG. 4 shows a sample historical record generated by software used in association with a monitor according to one preferred embodiment of this invention;

FIG. 5 shows a sample report generated by software used in association with a monitor according to one preferred embodiment of this invention;

FIG. 6 shows a schematic of a monitor according to one preferred embodiment of this invention;

FIG. 7 shows a flowchart of a method for monitoring molding processes according to one preferred embodiment of this invention;

FIG. 8 shows a perspective back view of a monitor having a removal sensor, according to one embodiment of this invention; and

FIG. 9 shows a perspective front view of a monitor and a printed circuit board, according to one embodiment of this invention.

### DETAILED DESCRIPTION OF THE PREFERRED EMBODIMENT

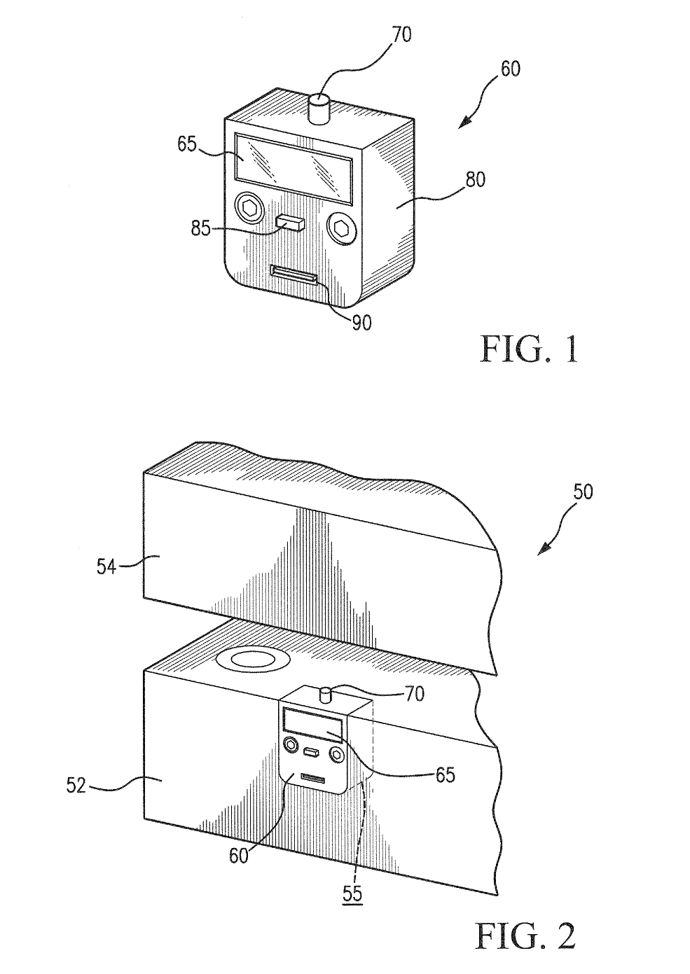

As shown in FIGS. 1 and 2 for purposes for illustration, a monitor 60 is used in connection with a mold 50. As shown in FIG. 2, the mold 50 includes a first mold half 52 and a second mold half 54. The first mold half 52 and the second mold half 54 preferably reciprocate relative to each other to result in closure of the mold 50, the molding operation and a resulting molded component. For instance, the first mold half 52 may be mounted for reciprocal movement on four posts which are stationary or fixably mounted at their ends to the second mold half 54 and the first mold half 52 may be closed relative to the second mold half 54 to complete a typical molding cycle within a molding press.

The term “mold” as used herein refers to mold bases or frames sold by mold manufacturers without the final cavity therein, as well as refers to molds that actually have the cavities therein. Thus, it is contemplated that a mold base or frame may be sold with a monitor or counter therein prior to actual cavity being formed. Similarly, although plastic injection molds are shown and described by example, the monitor 60 may be used in connection with any reciprocating, molding or cycling manufacturing equipment including but not limited to blow molding, stamping, die casting, etc.

According to a preferred embodiment of this invention, the mold 50 is provided with the monitor 60. The monitor 60, which may also be referred to as “counter” herein, preferably includes an actuator 70. The actuator 70 is preferably triggered with each opening and closing movement of the mold 50 when it is in an injection molding press. The actuator 70 may comprise a mechanically and/or an electrically and/or magnetically actuated switch that registers following every actuation of the mold 50 within the molding press. According to one preferred embodiment, the actuator 70 is preferably positioned to generate and send a count signal following a mold operation.

According to one preferred embodiment, the actuator 70 is positionable between a released mode, such as when the mold 50 is open, and an activated mode, such as when the mold 50 is closed. The duration of both the released mode and the activated mode may be trackable and recorded by the monitor 60.

The monitor 60 preferably includes a housing 80 that is molded and/or otherwise formed into a body that is compatible with a pocket 55 or similar accommodation within the mold 50. The housing 80 is preferably formed of a rigid, sealable and/or enclosed body for substantially enclosing and protecting the internal electronics and devices of the monitor 60.

Preferably, an outer wall of the monitor 60 is substantially flush with an upper surface of either the first half 52 or second half 54 of the mold 50. In this manner, the actuator 70 may be engageable with a surface of an opposite second half 54 or first half 52 of the mold 50. As described above, the engagement may occur mechanically with a portion of the actuator projecting above the upper surface or otherwise through a magnetic and/or electrical engagement and actuation.

The monitor 60 additionally includes an internal power supply, such as a battery. The battery is preferably sealed within the housing 80 and therefore tamper resistant. According to one preferred embodiment of this invention, the battery is a ½ AA. It is contemplated in one preferred embodiment of this invention that the battery is not accessible following placement of the monitor 60 within the mold 50. As such, an extended battery life is a desired feature of the present invention.

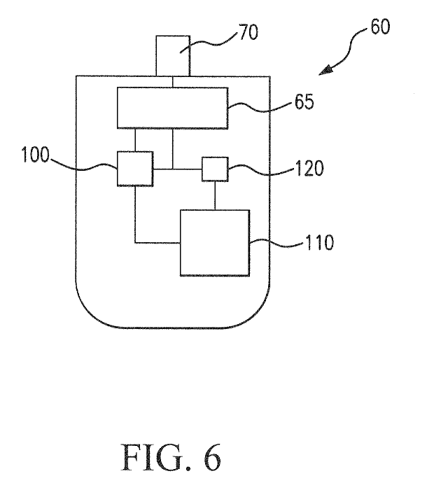

In addition, and as shown schematically in FIG. 6, the monitor 60 preferably includes a processor 100 within the housing 80. A processor 100 is preferably positioned with respect to the housing 80, and preferably sealed therein. The processor 100 preferably comprises a generally compact or micro device that converts an input to an output, such as a CPU and associated memory, as described in more detail below.

A non-transitory, computer readable medium 110, such as an internal memory, is preferably positioned within the housing 80 and is electronically connected with the processor 100, the actuator 70, and, preferably, an electronic display 65. As described, the actuator 70 preferably tracks cycle count and sends a count signal to the processor 100. Using cycle count information from the actuator and time information sent from the timer 120, the processor 100 generates average cycle time and the activity percentage of the mold 50. As used throughout this specification, the drawings and in the claims, the term “activity percentage” is intended to be interchangeable with the term “efficiency percentage,” and the term “activity percentage recent” is intended to be interchangeable with the term “efficiency percentage recent.” The computer readable medium 110 then stores the mold data, including, but not limited to, total count, the average cycle time and the activity percentage of the mold. This data is preferably retained independent of a malfunction by the mold 50 and/or the monitor 60. In this manner, the cycle and other information is retained when the mold 50 is removed from the molding press and moved to a new molding press or stored during downtime.

The monitor 60 according to this invention preferably tracks one or more of the following sets of information: Total Cycles; Total Time; Active (Up) Time; Idle Time; Idle Time Total; Active (Up) Time Average; Sleep Time; Sleep Time Total; Cycle Time; Average Cycle Life to Date; Average Cycle Recent; Activity Percentage; Activity Percentage Recent; Resettable Trip Count; Down Days; Days Initiated; Battery Level; Segment Time; Device ID; Mold ID; PM Cycles; Retrofit Cycles; Monitor Removals; Battery Alert; and/or Preventive Maintenance Alert. Each of these categories will be described in more detail in the following discussion.

Total Cycles includes the cycle count as described above. A cycle is generally defined as the opening and closing of a tool that creates a pulse by the actuator 70. That is, every actuation of the mold results in an additional cycle count. Such Total Cycles is important when tracking maintenance requirements for the particular mold 50 to which the monitor 60 is associated. The Total Cycles are also applicable to inventory management and/or manufacturing analysis.

In addition, the monitor 60 may further generate an Interim Cycle Count in addition to a Total Cycle count. A user may temporarily reset the Total Cycle count to obtain an temporal or interim cycle count during an interim molding operation. The monitor 60 preferably also includes an internal clock or timer 120 to time a molding cycle and a means to provide an average production cycle time for the molder. The timer 120 is preferably electronically connected with the processor 100. In this manner, Average Cycle Time may be measured which may account for an average cycle during a specified time period, for instance, an average cycle time since the mold 50 was most recently placed into service. The Average Cycle Time preferably includes the total time the mold was active divided by the total cycles. Preferably the active time does not include time that the mold was intentionally idled, or sleep time, which is described in more detail herein. In addition, an Average Cycle Life to Date may be calculated which determines an average cycle time from the first operation of the mold 50, or more specifically, an average cycle time since the monitor 60 was first associated with the mold 50. In addition, a Days Initiated or similar time interval since inception or “date of birth” may be tracked to determine the total service time of the mold 50 associated with the respective monitor 60.

The timer 120 preferably further includes an active mode and a sleep mode depending on the state of operation of the associated mold 50. Specifically, during generally constant operation of the mold 50, the timer 120 preferably maintains the active mode. However, should the mold 50 discontinue operation for a predetermined period of time, for instance, six hours, or any other suitable time increment indicating discontinuance of ordinary molding operations, then the monitor 60 enters sleep mode.

The timer 120 may further record and track the total duration of each of the released mode and the activated mode of the actuator 70, as described above. The actuator 70 may thereby generate and send a release signal when the mold is open and generate and send an active signal when the mold is closed. The processor 100 preferably receives these signals and then tracks a duration of time of each of the release signal and the active signal. Such measurements may be used in the calculation of various data fields including activity percentage and average cycle time.

According to a preferred embodiment of this invention, the monitor 60 may additionally include an internal date or calendar so that the date of usage of the mold 50 and/or placement into service may also be stored and retrieved. Alternatively, the user can record a service entry date and use the internal clock described above to count from the service entry date as a baseline and therefore constructively maintain day and date interval counting. In this manner, the monitor 60 may record Idle Time or Down Days or similar downtime information. Likewise, operation time may be compared with downtime and/or sleep time to reach an Activity Percentage. Activity Percentage is defined generally as for the life of the mold, the time that the mold is active based on the total available time it could be active. The calculation is generally up or active time divided by up or active time plus idle time. According to a preferred embodiment, the processor 100 discards idle time of the mold in excess of a predetermined limit (sleep time) to determine an Activity Percentage. In this regard, the timer 120 preferably activates the sleep mode following mold inactivity exceeding a predetermined threshold, such as six hours.

The monitor 60 may further record an in-service or “born-on” date based on when a battery is inserted and the monitor 60 is turned on for the first time. As a result, the monitor 60 preferably records and provides the time and/or dates on which the mold 50 was placed into production and the associated Total Cycles for this usage period. In this manner, a history may be developed to readily determine important manufacturing information about the mold 50.

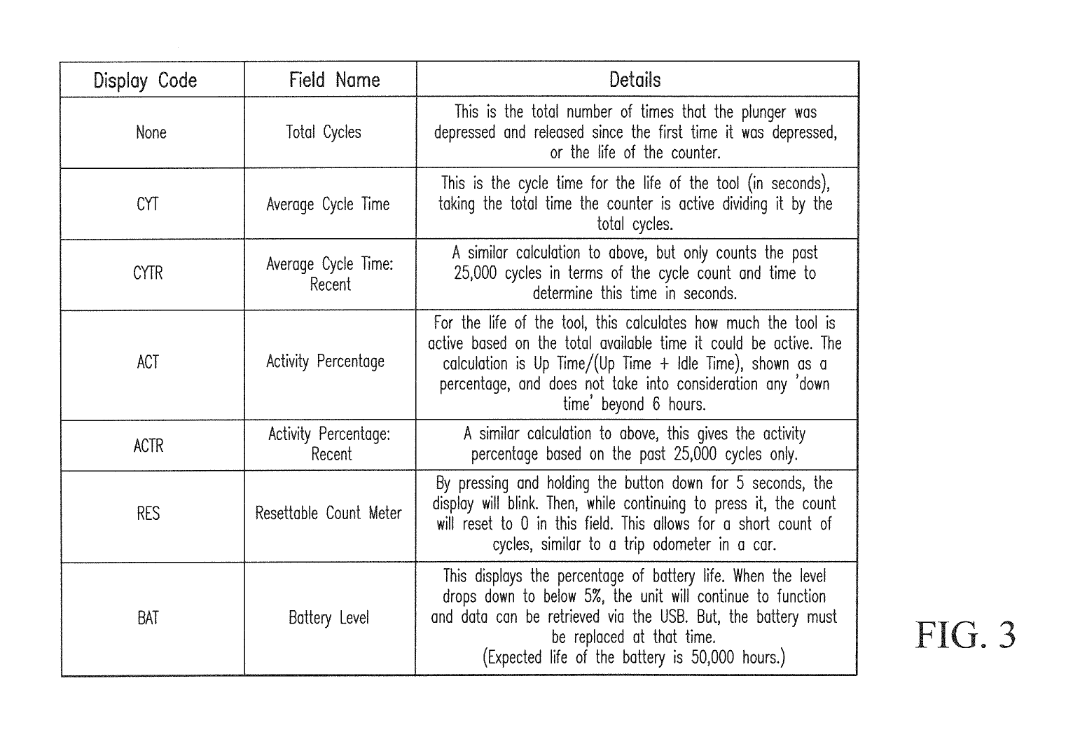

According to a preferred embodiment of this invention, the monitor 60 may further include a display 65, such as an electronic display positioned with respect to the housing 80, for example an LED or LCD display that provides one or more of the preceding or following data categories. Such data categories are preferably shown on the display 65 in a readily viewable manner, such as in sequence, either automatically or by a function button that permits a user to scroll through such data categories. FIG. 3 is exemplary of such data categories that may be viewable on the display 65. The function button is preferably positioned in an outwardly exposed, prominent portion of the housing 80 and electronically connected with the display 65 and the processor 100 to generate one or more preferred data categories.

According to a preferred embodiment of this invention, a default setting of the display 65 includes a powered-off or blank display, that is, an absence of any data categories thereby conserving the battery or other power supply within the monitor 60. In such a default setting of the display 65, the Total Cycles is preferably most readily accessible to a user, either on an automatic periodic basis or through actuation of a function button on the monitor 60.

Although the monitor 60 is capable of real-time counting and display, a battery conserve state may keep the display screen off as the monitor 60 is actuated, for instance as a magnet engages a surface of the monitor 60. The display 65 in such a battery conserve state may update in predetermined increments, depending on the cycle time or the intentions of the user. The sleep mode and the battery conserve state may be coordinated or separate operational modes of the monitor 60. In addition, a user interface, such as a function button on the monitor 60 may permit the user to view an actual datapoint in realtime, regardless of a particular current mode of the monitor 60, including a moving counter after the monitor 60 is placed into the mold 50.

According to one preferred embodiment of the invention, a default display interface will include: Total Cycles; Average Cycle Recent; Average Cycle Life to Date; Days Initiated; Idle Time Total; Activity Percentage; Battery Level Percentage; and Device ID. FIG. 3 shows an example of displays showing representative outputs. In other embodiments of this invention, a default display interface may also include Retrofit Cycles, Monitor Removals, Battery Alert and/or Preventive Maintenance Alert.

According to a preferred embodiment of this invention, a Battery Level and/or Battery Level Percentage may be included in the information available from the monitor 60. The Battery Level may be shown on display 65 or, like all data categories described herein may be tracked and displayed periodically and/or in real time on an external display that is connected to or connectable with the monitor 60.

According to a preferred embodiment of this invention, a Segment Time may be set and/or adjustable within the monitor 60. The Segment Time is preferably the interval in which the monitor writes data to internal storage, such as the internal memory. This Segment Time may or may not correspond with a time to sleep mode described herein. For instance, a battery conservation mode of the monitor 60 may write gathered data to storage, such as internal memory every 120 minutes. In this manner, battery life may be further conserved by minimizing the activity required of the monitor 60 during operation of the press. According to a preferred embodiment, the monitor 60 can maintain multiple segments, for instance eight segments or sessions. In this embodiment, when a ninth session is initiated, the first or oldest session is preferably overwritten. In other embodiments, monitor 60 can maintain or include 52 total sessions. The monitor 60 may be programmed to permit any desirable number of segments or sessions.

The monitor 60 may additionally include an on/off switch. However, such on/off switch may solely be associated with the display and preferably does not prevent the recording and collection of any category of data described herein.

In addition, a Device ID, a Mold ID, a Part ID, an Asset ID and/or a Program Name may be programmed into the monitor 60. In this manner, a user can maintain a positive connection between the mold 50 and the monitor 60 to ensure that the gathered data is correctly assigned to the intended mold 50 and/or press.

According to one preferred embodiment of this invention, Preventative Maintenance (“PM”) Cycles and/or a countdown to scheduled PM may additionally be included as a data category in and/or from the monitor 60. Preferably, when the mold 50 has been cycled through to the desired PM Cycles and/or scheduled PM date, an alarm or indicator is triggered to alert the user that mold maintenance is required. Such an alarm or indicator may be external to the monitor 60, such as a flashing warning, or may be external coupled with the monitor 60 such as a warning light on the press containing the mold 50.

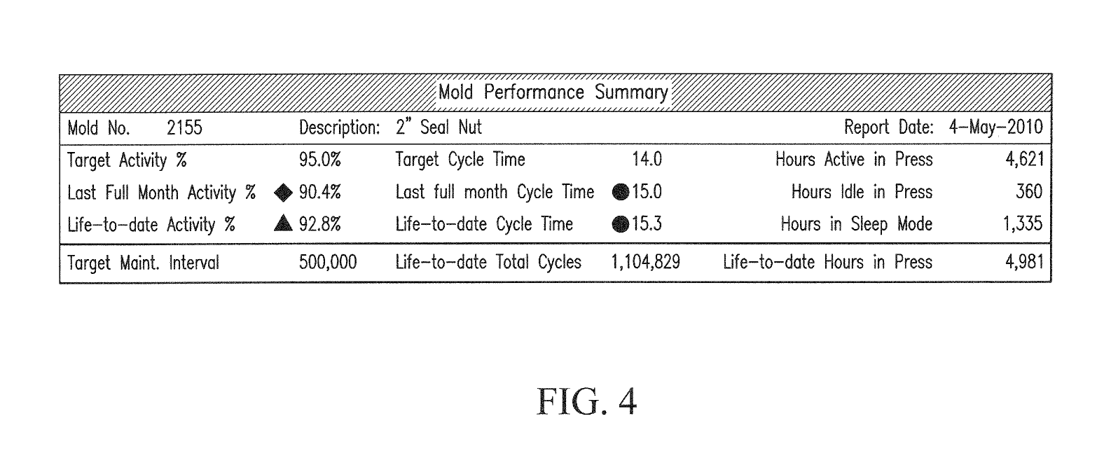

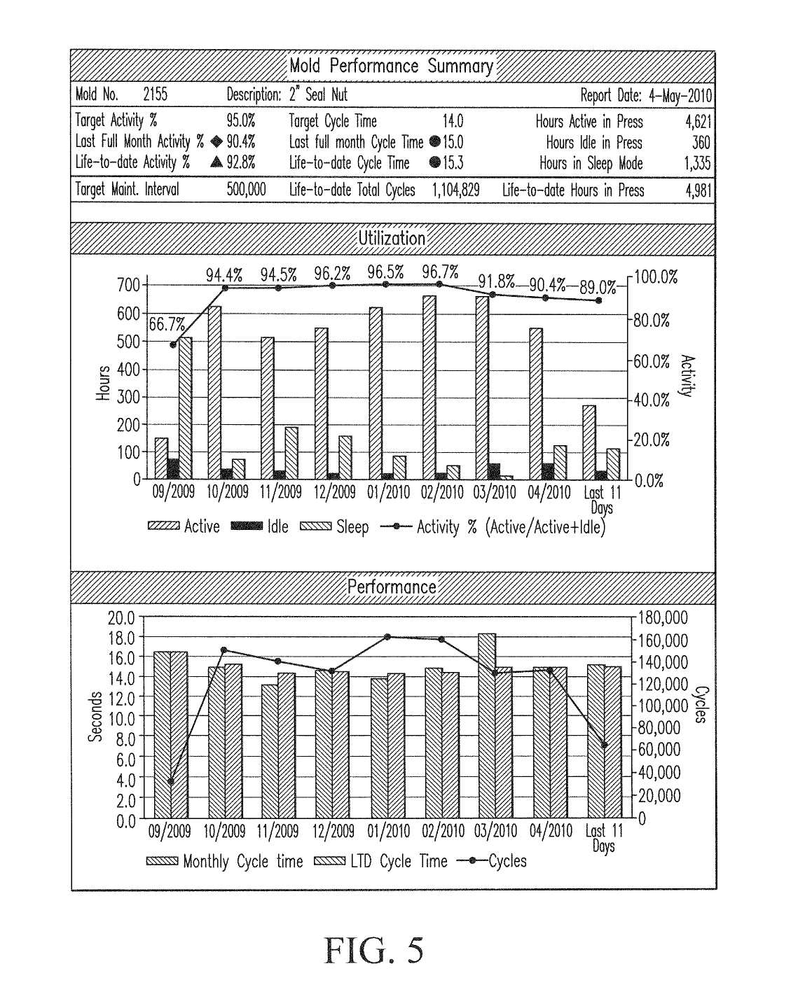

With the one or more collections of the foregoing information, an OEM manufacturer, molder and/or moldmaker can create a history of the operation of the mold including the number of specific parts made, the date of manufacture, average cycle time and/or other information so as to provide a better history with respect to when maintenance should be made and what type of maintenance should be used. Examples of such histories or reports are shown, by illustration, in FIGS. 4 and 5.

In some embodiments of this invention, it is possible to detect removal of monitor 60, for example, from its mounted or engaged position, such as shown in FIG. 2, with respect to mold 50 and/or first half 52. There can be times when an owner, an OEM and/or another interested third party wants to know and/or be informed that monitor 60 has been removed from its mounted or engaged position, for example, if the molder is running mold 50 in an unauthorized manner or without authorization. In some embodiments of this invention, removal of monitor 60 can be detected and recorded as proof that monitor 60 has in fact been removed, particularly in situations in which monitor 60 can then be used in an unauthorized manner to produce unauthorized additional molded parts.

In some embodiments of this invention, there are needs to remove monitor 60, for example, for cleaning or other maintenance or preventive maintenance purposes. In some embodiments or this invention, it is possible to detect a difference between removing monitor 60 for authorized purposes and for unauthorized purposes. In some embodiments of this invention, monitor 60 is removed in an unauthorized manner to avoid showing additional or extra counts on the counter of monitor 60 which is operated by actuator 70, for example, so that a mold can be used to make unauthorized additional molded parts.

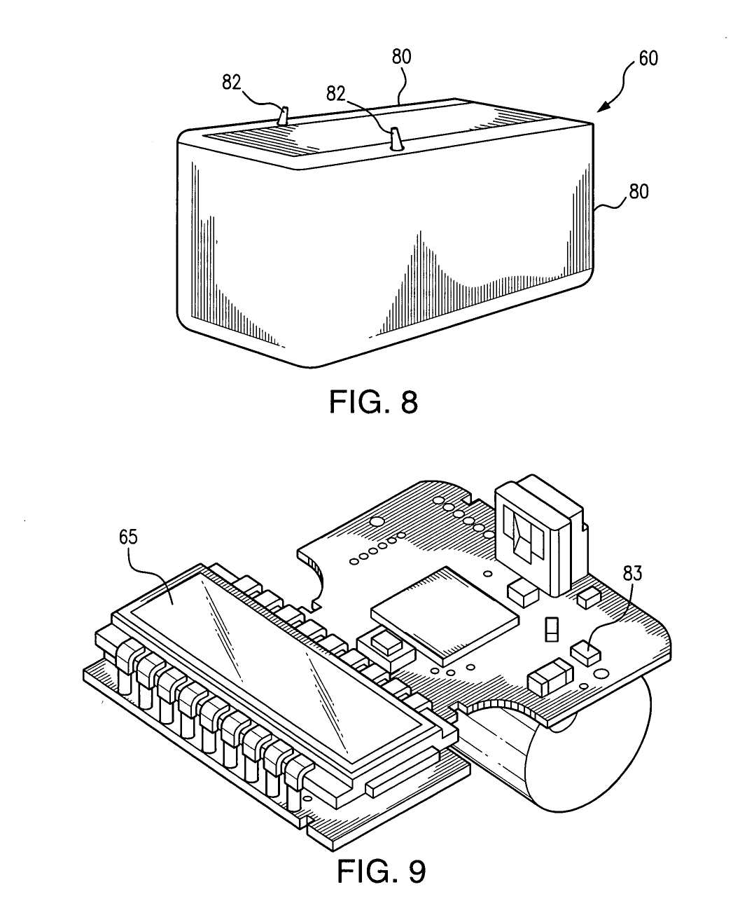

In some embodiments of this invention, at least one actuation device is moved or otherwise actuated or operated when monitor 60 is removed from its mounted or engaged position with respect to mold 50. FIG. 8 shows one embodiment of an actuation device comprising two pins 82 each movably mounted with respect to housing 80 of monitor 60. Each pin 82 can be mounted in any suitable mechanical, electrical, magnetic and/or other movable manner, so that applying a force to pin 82 moves or actuates pin 82 with respect to housing 80. In some embodiments of this invention, pin 82 can be moved with respect to housing 80, for example, to form an electrical connection, a mechanical connection, a magnetic connection and/or any other suitable connection that results in generating a signal which can be processed and/or assessed to determine whether monitor 60 is either in its mounted position or its engaged position with respect to mold 50.

In some embodiments of this invention, at least one pin 82 is a Pogo pin that when actuated forms an electromechanical connection and communicates a signal, in a wired and/or wireless manner, to processor 100, for example, to show that monitor 60 has been dismounted or disengaged from its mounted or engaged position with respect to mold 50. FIG. 8 shows two pins 82, each a Pogo pin, movably mounted within suitable bores and/or other suitable voids of or within a surface, such as a back surface, of housing 80. In some embodiments of this invention, each Pogo pin is actuated by seating, mounting, engaging and/or otherwise moving housing 80 within pocket 55 or another suitable receiver and/or void which movement applies a force, such as an actuation force, acting on each Pogo pin by contacting and applying a force to pin 82. In some embodiments of this invention, each Pogo pin or other suitable pin 82 is pressed against mold 50 or another suitable tool, for example, and the force acting on pin 82 and the resulting movement causes a circuit, such as an electrical circuit, to close and/or open. In some embodiments, when monitor 60 is dismounted, disengaged and/or otherwise removed, pin 82 extends out or away from housing 80 and triggers or initiates an event or time and cycle stamp on the device. This removal is shown on display 65, for example, as a quantity or amount of removals that have occurred. In some embodiments of this invention, this removal information appears in reports, for example, so that tool owners can understand if the data corresponds to normal molding practices and/or is authorized.

In some embodiments of this invention, the activation device is not visible and the cycle count can be achieved with, for example, a Hall effect sensor 83, such as shown in FIG. 9, which can be triggered, for example, by a magnet that operates a printed circuit board, such as shown in FIG. 9, and produces an end result that is similar to the result of operation of pins 82, such as the Pogo pins. With this type of an activation device, the sensor feels or senses that the electromagnetic circuit is complete, closed or open. If removed, in some embodiments, the magnet triggers and records an event locally on monitor 60 and/or sends a wired and/or wireless signal. This movement and thus resulting removal count in some embodiments is only visible by an authorized user, such as through an unlocked data analysis on a report generated in a software program and/or by data collected in real or actual time, such as on a live system. This data is important if a party, such as a customer and/or an OEM, sees inconsistent data at a tool maker, because the party can have a third-party service analyze the data and determine if there is a conflict or if the removals of monitor 60 are unauthorized.

In some embodiments of this invention, monitor 60 comprises preventive maintenance (PM) programming or software which can be integrated with monitor 60. Monitor 60 can communicate in a wired and/or wireless manner with a reporting device comprising a comprehensive reporting program and/or software, locally and/or remotely. For example, users can set an initial PM point, such as cycles, and then a desired interval between PM activities. In some embodiments of this invention, within any desired set point, such as 10% of the set cycle number, sometimes referred to as the PM due point, display 65 flashes an alert and/or an alarm. The user can activate a snooze, like on an alarm clock, to suppress or avoid the flash or other alert signal, particularly if the user delays the required PM activity. Every time the time or number of cycles reaches another PM due point, for example after another 10% increment is achieved, and no PM activity has been performed, display 65 can again flash or otherwise alert the user, and the user can again snooze the alert. In some embodiments of this invention, the user stops the alerts from recurring by connecting monitor 60, in a wired and/or wireless manner, to the comprehensive reporting facility, and noting or reporting that a PM event occurred. For example, in some embodiments of this invention, the user would select the reason for the report as a required PM activity. This user action can reset the due time to be within a desired range, such as 10% of the next interval count, and if the original target passes or is exceeded, the software or program can add the interval to the current cycles in order to achieve the next time that the PM activity needs to occur.

In some embodiments of this invention, the program or software has retrofit cycles as a programmed feature. In some embodiments, only the user sees this cycle count on the local and/or remote reports. In some embodiments, if a customer is replacing one type of mechanical counter or another type of counter with monitor 60 according to this invention, the user can enter the original or current number of cycles from the replaced counter, for example, when initializing monitor 60 of this invention, locally and/or remotely, and it can be shown on display 65, for example, by the user double clicking the button. In some embodiments of this invention, this allows the total cycles to be for the life of the new monitor 60, as installed on the tool, but also another mode can be shown on display 65, for example, to see all of the cycles that the tool has in its history.

In some embodiments of this invention, for example, a molder may not want all of the features to appear or show on display 65 so that confidential or unauthorized information is not available to be seen by press operators or other customers, for example. In some embodiments of this invention, the user can limit the display modes on display 65, for example, to see all data and/or information except for cycle times and efficiencies, such as over a lifetime and/or recent. In some embodiments of this invention, this is considered a mold counter mode and the user can set this using the software or program, locally and/or remotely.

In some embodiments of this invention, the software or program allows the user to generate reports and save them remotely and/or locally, in a wired and/or a wireless manner, on a computer or other suitable data storage and processing device, and communicate, such as by email, the report to another party, such as a customer or colleague, when running that same report, and in the case of the “O” OEM version, will back up to servers of a third party provider, such as for safety and security reasons. In some embodiments of this invention, the emailed or otherwise communicated versions are a protected file, such as an Excel file and/or a PDF file. According to this invention, customers concerned with emailing attachments that have data can now generate a report to an encrypted file (.enc) which is saved locally, remotely and/or emailed or otherwise communicated in the same manner as before. In these particular embodiments, the recipient needs to have the reporting software or program installed on their computer before the recipient can read the encrypted file. After saving the attachment on a computer readable medium, such as a computer and/or a server, the recipient can run the reporting software and/or program and, for example, open the report from a browsed folder.

In some embodiments of this invention, the reporting software and/or program can receive, process and/or store an additional identification of customer information. For example, the OEM versions can be identified by an OEM identifier, such as one previously assigned, and the part identification and mold identification can help identify one or more particular monitors 60, for example, when shipping monitor 60 into the marketplace, and the identifications can support initialization steps for entering data into the reporting software and/or program of this invention. In some embodiments of this invention, when purchasing, the user is asked for Part ID, Tool ID, Asset ID and/or Program Name. These 4 fields as well as an OEM ID, for example, assigned when partnering with the OEM for the sale, track the unit from the point of purchase through initialization of the device with the reporting software and/or program and appears on reports and/or within the live system. In some embodiments of this invention, this supports the customer installation process of the component, while assuring that all data and/or information are consistent with OEM specifications.

In some embodiments of this invention, a low battery indicator is a percentage and in other embodiments is a countdown clock within monitor 60 that flashes or otherwise alerts through display 65 and/or another warning device when monitor 60 is within a set time period, for example, 30 days from an end of life. In some embodiments of this invention, the user can snooze similar to the PM Due alert or alarm. Prior to the battery running out, the user can use the reporting software and/or program of this invention to clone or copy monitor 60, particularly if replacing or going from an existing to a new monitor 60, which can allow the data and/or information to be fully intact on the new monitor 60 which will likely have a new identification number, such as a new serial number.

Activity Percentage, both for the life of the tool and for a specified number such as the 25,000 most recent number of cycles, in some embodiments of this invention is listed as Efficiency Percentage, and in some embodiments the calculations are the same as for the Activity Percentage.

In some embodiments of this invention, the data and/or information can be stored on a relatively larger storage device, such as a larger flash drive for storing documents including part drawings, mold set up sheets and/or the like.

In some embodiments of this invention, monitor 60 has relatively good water resistance capabilities, for example, with specified designs of different elements, monitor 60 of this invention can withstand a steady stream of water and achieve an ingress protection rating of IP52.

According to a preferred embodiment of this invention, the monitor further includes a port 90 positioned within the housing 80 and electronically connected with respect to the non-transitory computer readable medium 110. The port 90 is preferably connectable to an external computer. The port 90 may comprise a USB port for connecting the monitor 60 to a computer, printer, PDA or similar device so that the history and average cycle time and/or total cycles as well as any stored maintenance information may be read, recorded and/or offloaded.

According to one preferred embodiment of this invention, information is exported into an internal and/or external memory of the monitor 60 in predetermined intervals. Included in such information is the mold downtime. For instance, assuming no molding cycle is over 200 seconds, the monitor is triggered to begin counting downtime. Information is preferably written in increments, for instance, two hour increments. Such incremental recording of downtime and/or data storage assists in maintaining a long term battery life for the monitor 60.

The monitor 60 preferably operates in connection with bridge software to write the collected information to the internal and/or external memory of the monitor 60 and then permit retrieval of the collected information.

As described, a port 90, such as a USB port, a bluetooth interface and/or other wired or wireless connection may be used to connect with a storage device or a readout device, such as a local or networked computer, an internet site, a handheld, readout device or similar output device. The associated device may also be used to input information into the internal and/or external memory of the monitor 60 with respect to a particular desired setting, preventive maintenance operation or other data or operation so that the mold 60 includes an intended protocol or history of what maintenance has been accomplished or needs to be done.

According to one preferred embodiment of this invention, representative reports derived from the monitor 60 are shown in FIGS. 4 and 5. Such reports may be prepared in real time or in increments on schedule. The monitor 60 as described may also permit remote access to tool information for remote tracking and data analysis by the mold builder, the mold operator and/or suppliers or customers in the manufacturing supply chain. Such remote access may permit resupply of maintenance items as well as just-in-time scheduling. Essential information regarding the mold or group of molds may be organized, updated and stored including part name, part id, mold id, number of cavities, etc. Status of multiple mold groupings may be tracked to consolidate information regarding a specific product's tooling program. Alerts may be provided on the mold and/or in the various reports that indicate inactivity affecting product launch or inventory requirements. Such alerts may be provided to the molder, mold operator, moldmaker and/or program managers through a personal computer, smart phone or similar delivery system.

The monitor 60 as described provides numerous benefits to users including access to actual manufacturing information maintained in real time, better documentation of systems, repeatability and tracing. Manufacturing assets may be better and more accurately tracked and real time “post mortem” information is available should a tool or press unexpectedly cease operation. Likewise, process parameters are readily accessible and preventative maintenance schedules are readily viewable, budgetable and predictive. In addition, users are aware of mold usage, can improve scheduling capability, capacity utilization and can store and view auxiliary equipment notes.

In this regard, the monitor 60 may include a serial number physically affixed to a surface of the housing 80 for association between the monitor 60 and the particular mold 50. As a result of the association between the monitor 60 and the mold 50, a manufacturer may then monitor mold data and thereby improve mold maintenance. Specifically, for example, a user may enter the serial number of the particular monitor 60 into an electronic database or website, such as www.profilecv.com, and track the particular performance of the mold 50 associated with that monitor 60. If no data exists for the particular monitor 60, the user may be provided with an overview of available information for the monitor 60 and/or mold 50. Data similar to that shown in FIGS. 4 and 5 may then be available, on a remote but secure basis.

In addition, according to one preferred embodiment of this invention, the monitor 60 and/or related software may include sufficient memory to permit on-mold storage of piece part or mold prints, files, manufacturing specifications and other critical data related to the part to be manufactured and/or the mold. In addition, a GPS or RFID may be provided within or in association with the monitor 60 to permit location tracking of the mold. Further, mold diagnostic and telemetry sensors and equipment may be connected with respect to the monitor 60 to provide temperature monitoring and similar information in association with the reports discussed herein.

Accordingly, a method for retrieving mold cycle data in accordance with the subject invention includes positioning the monitor 60 with respect to the mold 50; recording a number of cycles generated by the mold 50; recording a time that the mold is in operation (or active); recording a time that the mold is not in operation (or idle or in sleep mode); and generating an average cycle time and an activity percentage of the mold 50. The subject method may or may not include the monitor 60 entering a sleep mode following mold inactivity exceeding a predetermined threshold. According to one embodiment, the following data is gathered and/or calculated by the monitor 60, and in other embodiments of this invention more or less data can be gathered, calculated and/or displayed by monitor 60.

| Abbreviation | Definition | Details |
|---|---|---|
| TC | Total Cycles | The total cycles, or times the monitor was depressed |
| | | and released, or “plunged.” |
| TS | Total Seconds | The total time in seconds that were expended since |
| | | the first plunge, or the ‘age’ of the monitor. |
| UT | Up Time | The time in seconds that the counter was |
| | | plunging/activating. |
| IT | Idle Time | Idle time is when the mold is in the press but is not |
| | | plunging or active. After 200 seconds, Idle Time |
| | | starts-and continues until the mold activates again |
| | | OR 6 hours of time is reached-which constitutes |
| | | Sleep Time. |
| ITT | Idle Time: Total | The sum of all the Idle Times recorded previously. |
| UTT | Up Time: Total | The sum of all the Up Times recorded previously. |
| ST | Sleep Time | Once the counter is sitting idle for 6 hours, that time |
| | | from the 200 second point through the 6 hour point- |
| | | and any time further until the counter activates again- |
| | | is considered Sleep Time. |
| STT | Sleep Time: Total | The sum of all the Sleep Times recorded previously. |
| CYT | Cycle Time | The Cycle Time recorded for the life of the tool, same |
| | | as on the display. |
| CYTR | Cycle Time: Recent | The Cycle Time for the past 25,000 cycles. |
| ACT | Activity Percentage | Activity Percentage for the life of the mold. |
| ACTR | Activity Percentage: | Activity Percentage based on the past 25,000 cycles. |
| | Recent | |
| RES | Reset Count | If the ‘trip meter’ or interim cycle counter was used |
| | | for the monitor, the last recorded value of that reset |
| | | number is listed. |
| BAT | Battery Level | The percentage of battery life. |
| ID | Counter | Each monitor will have a unique ID for the internal |
| | Identification | mechanics/software, which is different than the |
| | | serialization on the front face of the monitor. |
| CD | Cycle Difference | This is a mathematical field that calculates the total |
| | | cycles from the current session minus the cycles from |
| | | the last session. |

From the foregoing, it is seen that there is provided a device which serves as a monitor and/or counter for an injection mold, stamping dies, similar mold and/or similar reciprocating tooling which is relatively inexpensive and yet generates an accurate history of the extent and usage of the mold for particular molded parts. Preferably, the monitor is more sophisticated than a simple counter and records therein mold identification information, part identification information, average cycle time information as well as actual dates and quantities of parts molded over particular times. The invention is particularly useful in that accurate information is retained about the usage of the mold and timely, proper maintenance can be more readily facilitated.

As described in more detail as follows, the subject monitor 60 may be offered by a manufacturer or distributor to a moldmaker that manufactures injection molds or similar reciprocating tooling to a predetermined specification; a molder that manufactures plastic or stamped parts from the tooling to a predetermined specification; and/or an OEM manufacturer that provides desired parameters and specifications to the moldmaker and/or the molder. In addition, a molding coordinator may coordinate the mold construction and components as well as the molding process and parameters on behalf of the OEM and/or other parties.

According to a preferred system utilizing the monitor 60, a moldmaker (for instance, ABC Mold) may purchase the monitor 60, resulting in logging a Customer Name, a Device ID, and a Date into an electronic database, such as Microsoft Excel, within a network file storage and/or a local file storage. The moldmaker may additionally provide the molder recommended maintenance increments as part of a mold warranty.

A molder (for instance, XYZ Molding) utilizing the monitor 60 within a mold may wish to connect to the monitor 60 either as part of maintenance requirements, or for a general query or program related to mold performance. This access may be coordinated through an OEM manufacturer/owner of the tooling or may be separately accessible. After loading the software, the molder will contact the seller of the monitor 60 or the molding coordinator to receive a password and/or access code. The molder will then enter a unique access code and read and accept a Terms and Conditions document for access to the data generated and maintained by the monitor 60. Following acceptance of the Terms and Conditions, the molder, XYZ Molding, can pull data from the monitor 60 during operation.

When the molder synchronizes the monitor 60, an email with the Device ID activity log is preferably automatically sent to an e-mail address maintained by a molding coordinator, where it will reside generally without oversight. The seller of the monitor will preferably not have realtime access to the e-mails and the data therein.

If the buyer of the monitor 60, in this example, the moldmaker ABC Mold, receives the mold back from the molder XYZ Molding, the moldmaker will have the ability to check various performance parameters tracked by the monitor 60. In such a way, the moldmaker can confirm that the molder operated the mold under the intended parameters, including recommended maintenance measures and intervals, and in accordance with the quoted cycle times and cycles. As a result, if the mold was abused or otherwise used outside of quoted parameters, the moldmaker may be able to address any such discrepancies with the molder and thus repairs and/or maintenance may be properly attributable to the responsible party.

In the unlikely event that the monitor 60 is dead or otherwise inactive, either through deliberate action or otherwise, the moldmaker may contact the molding coordinator for limited access to the gathered data. Because there was an initial log of the Purchaser and Device ID, the molding coordinator can verify that the user is legitimate, and forward the activity log to the contact at the molder, ABC Mold. If the mold was run at more than one location, there will be activity logs for each location and the molding coordinator would forward these to the purchaser, such as the moldmaker.

The above scenario is generally applicable for the moldmaker/molder business relationship, referred to as the “M” version of this system. In this scenario, the backed-up data is generally not strategic nor sensitive. Specifically, general molding data would be available without specificity as to production details. For instance, a general part number, cycle time and quantity may be retrievable but not specifics regarding the part name, function, efficiencies and other details germane to the overall molding program. The molding coordinator would charge a nominal fee for generating a suitable generic report to the purchaser.

Another scenario generally involves an OEM manufacturer, such as an automotive company or handset manufacturer, referred to as the “0” version of the described system. In the “0” version of the system, the OEM manufacturer contracts with a molding coordinator to install “System Monitoring.” System monitoring preferably includes monitors 60, related software to the OEM's molders and/or moldmakers, and periodic audits of not only mold activity (maintenance) but also mold performance (speed, efficiency). This data is extensive and may often be deemed sensitive, but the OEM manufacturer has an interest and a right to require transparency throughout the supply chain. In this scenario, the molder, XYZ Molding, may do the initial purchase of the device, or may have purchased the mold from a moldmaker, ABC Mold. When XYZ Molding is synching the monitor at various manufacturing increments, their local hard drive will include reports saved for their own use to improve efficiencies. In addition, the molding coordinator will preferably provide periodic reports (for example, twice monthly) to the OEM manufacturer for the OEM manufacturer's molds, by compiling the data that is emailed to the molding coordinator automatically at the synchronization of the monitor 60. In this scenario, the molder, ABC Mold, would still have a right to audit the Activity Log, through the molding coordinator, but would not have the ability to access detailed performance reports. At the OEM manufacturer's election, the molder, ABC Mold, can buy and install the monitor 60 at the outset and then obtain access to this information.

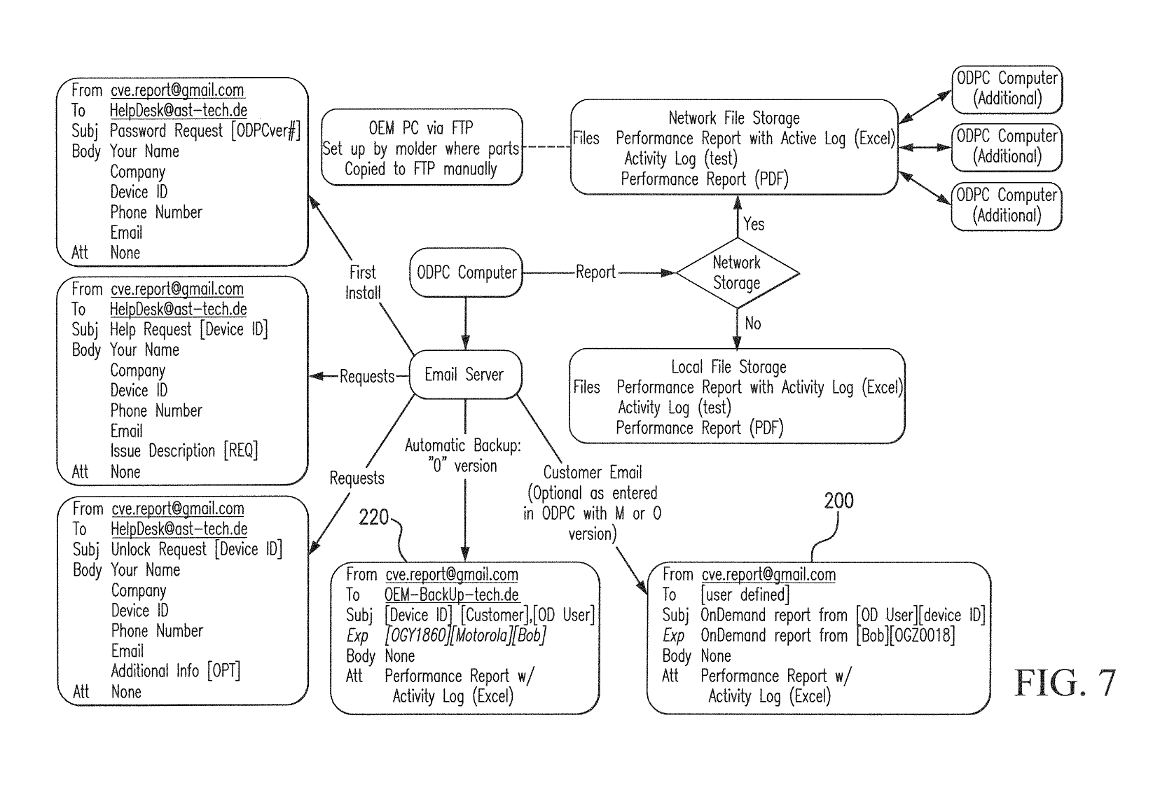

FIG. 7 shows a flowchart of a preferred method for monitoring a reciprocating tool that includes assigning an electronic monitor to a particular reciprocating tool as described above. Specifically, as best shown in FIGS. 1 and 2, the electronic monitor 60 is positioned within the reciprocating tool, such as mold 50, to record a count signal following each operation of the mold 50.

As shown in FIG. 7, an automated first remote record of the operation of the reciprocating tool is maintained preferably through a customer e-mail, as shown in element 200. This first remote record 200 may be any number of the operation parameters described herein and may be specifically tailored to the customer by the distributor and/or the molding coordinator. In addition, an automated second remote record 220 of the operation of the mold 50 is generated. In this operation, the second remote record 220 preferably includes a “stripped-down” version or variation of the first remote record 200, preferably having less detail than the first remote record 200. According to one preferred embodiment of this invention, the second remote record 220 includes a non-confidential version of the first remote record 200. Alternatively, the second remote record 220 may include different information from the first remote record 200. In theory, the first remote record 200 may include all the mold data collected and available by the monitor 60 while the second remote record 200 includes some limited subset of the first remote record 200. Additional records and/or reports may also be produced as desired, including maintenance records and/or reports or very general reports for more general audiences.

As described above, the first remote record may be provided to an operator of the reciprocating tool and the second remote record may be provided to a builder of the reciprocating tool, or vice-versa. In this manner, the tool owner, such as an OEM manufacturer, can control the information provided to the various manufacturing partners without providing a potentially confidential overall picture of the molding operations. For example, a molder in China can pull information, in the form of a remote record, from the reciprocating tool in real time while the OEM manufacturer receives a secure e-mail provided either the same information or a desired variation of the information.

A third party molding coordinator may alternatively or additionally coordinate the operation of the reciprocating tool among an OEM manufacturer, a moldmaker and a molder. The molding coordinator may allocate (provide or withhold) at least one of the first remote record and the second remote record to the moldmaker and/or the molder based upon parameters determined by the OEM manufacturer. For example, an activity report may be generated from the second remote record and provided to the moldmaker only following a request from the OEM manufacturer.

In each described case, the first remote record and/or the second remote record may be remotely accessed by one or more of the various parties through network file storage, local file storage, e-mail servers, hard reports or other methods, such as shown in FIG. 7. In addition, such access is preferably secured access which may be provided only to the desired and intended party or parties.

While specific embodiments have been illustrated and described, numerous modifications come to mind without significantly departing from the spirit of the invention and the scope of protection is limited by the scope of the accompanying claims. These modification include, but are not limited to, replacing other types of cycle counters with cycle counters made according to the present invention and or retrofitting other types of cycle counters using the principles of the present invention.

1. A method for monitoring a reciprocating tool comprising:
positioning a monitor in a mounted position with respect to the reciprocating tool;
the monitor recording mold data of the reciprocating tool;
detecting a removal of the monitor from the mounted position; and
recording the removal of the monitor from the mounted position.

2. The method of claim 1 further comprising the step of reporting the recorded removal of the monitor from the mounted position to a local storage device and/or a remote storage device.

3. The method of claim 1 further comprising the step of reporting the recorded removal of the monitor from the mounted position to an owner of a mold of the reciprocating tool.

4. The method of claim 3 wherein the recorded removal is reported to the owner in a wired manner and/or a wireless manner.

5. The method of claim 1 wherein an actuation device is moved and detects the removal of the monitor from the mounted position.

6. The method of claim 1 wherein a movable pin is moved and detects the removal of the monitor from the mounted position.

7. The method of claim 6 wherein moving the movable pin opens and/or closes an electrical circuit and triggers the recording of the removed monitor.

8. The method of claim 7 wherein the removed monitor is reported to an owner of a mold of the reciprocating tool.

9. The method of claim 1 wherein a sensor is operated and detects the removal of the monitor from the mounted position.

10. The method of claim 9 wherein operating the sensor opens and/or closes an electrical circuit and triggers the recording of the removed monitor.

11. The method of claim 10 wherein the removed monitor is reported to an owner of a mold of the reciprocating tool.

12. A method for detecting an unauthorized use of a mold of a reciprocating tool, the method comprising:
mounting a monitor in a mounted position with respect to the mold; and
detecting and recording a removal of the monitor from the mounted position.

13. The method of claim 12 further comprising the step of reporting the recorded removal of the monitor from the mounted position to a local storage device and/or a remote storage device.

14. The method of claim 12 further comprising the step of reporting the recorded removal of the monitor from the mounted position to an owner of a mold of the reciprocating tool.

15. The method of claim 12 wherein an actuation device is moved and detects the removal of the monitor from the mounted position.

16. The method of claim 15 wherein actuating the actuation device opens and/or closes an electrical circuit and triggers the recording of the removed monitor.

17. The method of claim 16 wherein the removed monitor is reported in a wired manner and/or a wireless manner to an owner of the mold.

18. A method for monitoring a reciprocating tool comprising:
positioning a monitor in a mounted position with respect to the reciprocating tool;
the monitor recording mold data of the reciprocating tool;
detecting a requirement for a scheduled preventive maintenance activity; and
sending an alert identifying the requirement for the scheduled preventive maintenance activity.

19. The method of claim 18 wherein the alert is shown locally on a display of the monitor.

20. The method of claim 18 wherein the alert is communicated remotely to a reporting device.

21. The method of claim 20 wherein the reporting device comprises a reporting program and/or software.

22. The method of claim 18 wherein a snooze command is issued to suppress the alert.
